(19) United States
(12) Patent Application Publication
(10) Pub. No.: US 2016/0014592 A1
(43) Pub. Date: Jan. 14, 2016

(54) METHOD AND APPARATUS FOR TRANSMITTING MOBILITY PARAMETERS IN WIRELESS COMMUNICATION SYSTEM

(71) Applicant: LG ELECTRONICS INC., Seoul (KR)

(72) Inventors: Kyungmin PARK, Seoul (KR); Insun LEE, Seoul (KR); Daewook BYUN, Seoul (KR); Jian XU, Seoul (KR)

(73) Assignee: LG ELECTRONICS INC., Seoul (KR)

(21) Appl. No.: 14/776,137

(22) PCT Filed: Apr. 1, 2014
(86) PCT No.: PCT/KR2014/002753

§ 371 Date: Sep. 14, 2015

Related U.S. Application Data
(60) Provisional application No. 61/807,298, filed on Apr. 1, 2013.

(51) Int. Cl. H04W 8/08; H04W 16/18; H04W 36/00

(52) U.S. Cl. CPC H04W 8/08; H04W 36/0061; H04W 16/18

(57) ABSTRACT

A method and apparatus for transmitting mobility parameters in a wireless communication system is provided. A first eNodeB (eNB) transmits first mobility parameters for at least one of a cell range expansion (CRE) user equipment (UE) and second mobility parameters for a non-CRE UE to a second eNB. The CRE UE may include a UE which is configured with an almost blank subframe (ABS).

### TECHNICAL FIELD

The present invention relates to wireless communications, and more particularly, to a method and apparatus for transmitting mobility parameters in a wireless communication system.

### BACKGROUND ART

Universal mobile telecommunications system (UMTS) is a 3rd generation (3G) asynchronous mobile communication system operating in wideband code division multiple access (WCDMA) based on European systems, global system for mobile communications (GSM) and general packet radio services (GPRS). The long-term evolution (LTE) of UMTS is under discussion by the 3rd generation partnership project (3GPP) that standardized UMTS.

The 3GPP LTE is a technology for enabling high-speed packet communications. Many schemes have been proposed for the LTE objective including those that aim to reduce user and provider costs, improve service quality, and expand and improve coverage and system capacity. The 3GPP LTE requires reduced cost per bit, increased service availability, flexible use of a frequency band, a simple structure, an open interface, and adequate power consumption of a terminal as an upper-level requirement.

FIG. 1 shows LTE system architecture. The communication network is widely deployed to provide a variety of communication services such as voice over internet protocol (VoIP) through IMS and packet data.

Referring to FIG. 1, the LTE system architecture includes one or more user equipment (UE; 10), an evolved-UMTS terrestrial radio access network (E-UTRAN) and an evolved packet core (EPC). The UE 10 refers to a communication equipment carried by a user. The UE 10 may be fixed or mobile, and may be referred to as another terminology, such as a mobile station (MS), a user terminal (UT), a subscriber station (SS), a wireless device, etc.

The E-UTRAN includes one or more evolved node-B (eNB) 20, and a plurality of UEs may be located in one cell. The eNB 20 provides an end point of a control plane and a user plane to the UE 10. The eNB 20 is generally a fixed station that communicates with the UE 10 and may be referred to as another terminology, such as a base station (BS), a base transceiver system (BTS), an access point, etc. One eNB 20 may be deployed per cell. There are one or more cells within the coverage of the eNB 20. A single cell is configured to have one of bandwidths selected from 1.25, 2.5, 5, 10, and 20 MHz, etc., and provides downlink or uplink transmission services to several UEs. In this case, different cells can be configured to provide different bandwidths.

Hereinafter, a downlink (DL) denotes communication from the eNB 20 to the UE 10, and an uplink (UL) denotes communication from the UE 10 to the eNB 20. In the DL, a transmitter may be a part of the eNB 20, and a receiver may be a part of the UE 10. In the UL, the transmitter may be a part of the UE 10, and the receiver may be a part of the eNB 20.

The EPC includes a mobility management entity (MME) which is in charge of control plane functions, and a system architecture evolution (SAE) gateway (S-GW) which is in charge of user plane functions. The MME/S-GW 30 may be positioned at the end of the network and connected to an external network. The MME has UE access information or UE capability information, and such information may be primarily used in UE mobility management. The S-GW is a gateway of which an endpoint is an E-UTRAN. The MME/S-GW 30 provides an end point of a session and mobility management function for the UE 10. The EPC may further include a packet data network (PDN) gateway (PDN-GW). The PDN-GW is a gateway of which an endpoint is a PDN.

The MME provides various functions including non-access stratum (NAS) signaling to eNBs 20, NAS signaling security, access stratum (AS) security control, Inter core network (CN) node signaling for mobility between 3GPP access networks, idle mode UE reachability (including control and execution of paging retransmission), tracking area list management (for UE in idle and active mode), P-GW and S-GW selection, MME selection for handovers with MME change, serving GPRS support node (SGSN) selection for handovers to 2G or 3G 3GPP access networks, roaming, authentication, bearer management functions including dedicated bearer establishment, support for public warning system (PWS) (which includes earthquake and tsunami warning system (ETWS) and commercial mobile alert system (CMAS)) message transmission. The S-GW host provides assorted functions including per-user based packet filtering (by e.g., deep packet inspection), lawful interception, UE Internet protocol (IP) address allocation, transport level packet marking in the DL, UL and DL service level charging, gating and rate enforcement, DL rate enforcement based on APN-AMBR. For clarity MME/S-GW 30 will be referred to herein simply as a “gateway,” but it is understood that this entity includes both the MME and S-GW.

Interfaces for transmitting user traffic or control traffic may be used. The UE 10 and the eNB 20 are connected by means of a Uu interface. The eNBs 20 are interconnected by means of an X2 interface. Neighboring eNBs may have a meshed network structure that has the X2 interface. The eNBs 20 are connected to the EPC by means of an S1 interface. The eNBs 20 are connected to the MME by means of an S1-MME interface, and are connected to the S-GW by means of S1-U interface. The S1 interface supports a many-to-many relation between the eNB 20 and the MME/S-GW.

The eNB 20 may perform functions of selection for gateway 30, routing toward the gateway 30 during a radio resource control (RRC) activation, scheduling and transmitting of paging messages, scheduling and transmitting of broadcast channel (BCH) information, dynamic allocation of resources to the UEs 10 in both UL and DL, configuration and provisioning of eNB measurements, radio bearer control, radio admission control (RAC), and connection mobility control in LTE_ACTIVE state. In the EPC, and as noted above, gateway 30 may perform functions of paging origination, LTE_IDLE state management, ciphering of the user plane, SAE bearer control, and ciphering and integrity protection of NAS signaling.

FIG. 2 shows a control plane of a radio interface protocol of an LTE system. FIG. 3 shows a user plane of a radio interface protocol of an LTE system.

Layers of a radio interface protocol between the UE and the E-UTRAN may be classified into a first layer (L1), a second layer (L2), and a third layer (L3) based on the lower three layers of the open system interconnection (OSI) model that is well-known in the communication system. The radio interface protocol between the UE and the E-UTRAN may be horizontally divided into a physical layer, a data link layer, and a network layer, and may be vertically divided into a control plane (C-plane) which is a protocol stack for control signal transmission and a user plane (U-plane) which is a protocol stack for data information transmission. The layers of the radio interface protocol exist in pairs at the UE and the E-UTRAN, and are in charge of data transmission of the Uu interface.

A physical (PHY) layer belongs to the L1. The PHY layer provides a higher layer with an information transfer service through a physical channel. The PHY layer is connected to a medium access control (MAC) layer, which is a higher layer of the PHY layer, through a transport channel. A physical channel is mapped to the transport channel. Data is transferred between the MAC layer and the PHY layer through the transport channel. Between different PHY layers, i.e., a PHY layer of a transmitter and a PHY layer of a receiver, data is transferred through the physical channel using radio resources. The physical channel is modulated using an orthogonal frequency division multiplexing (OFDM) scheme, and utilizes time and frequency as a radio resource.

The PHY layer uses several physical control channels. A physical downlink control channel (PDCCH) reports to a UE about resource allocation of a paging channel (PCH) and a downlink shared channel (DL-SCH), and hybrid automatic repeat request (HARM) information related to the DL-SCH. The PDCCH may carry a UL grant for reporting to the UE about resource allocation of UL transmission. A physical control format indicator channel (PCFICH) reports the number of OFDM symbols used for PDCCHs to the UE, and is transmitted in every subframe. A physical hybrid ARQ indicator channel (PHICH) carries an HARQ acknowledgement (ACK)/non-acknowledgement (NACK) signal in response to UL transmission. A physical uplink control channel (PUCCH) carries UL control information such as HARQ ACK/NACK for DL transmission, scheduling request, and CQI. A physical uplink shared channel (PUSCH) carries a UL-uplink shared channel (SCH).

FIG. 4 shows an example of a physical channel structure.

A physical channel consists of a plurality of subframes in time domain and a plurality of subcarriers in frequency domain. One subframe consists of a plurality of symbols in the time domain. One subframe consists of a plurality of resource blocks (RBs). One RB consists of a plurality of symbols and a plurality of subcarriers. In addition, each subframe may use specific subcarriers of specific symbols of a corresponding subframe for a PDCCH. For example, a first symbol of the subframe may be used for the PDCCH. The PDCCH carries dynamic allocated resources, such as a physical resource block (PRB) and modulation and coding scheme (MCS). A transmission time interval (TTI) which is a unit time for data transmission may be equal to a length of one subframe. The length of one subframe may be 1 ms.

The transport channel is classified into a common transport channel and a dedicated transport channel according to whether the channel is shared or not. A DL transport channel for transmitting data from the network to the UE includes a broadcast channel (BCH) for transmitting system information, a paging channel (PCH) for transmitting a paging message, a DL-SCH for transmitting user traffic or control signals, etc. The DL-SCH supports HARQ, dynamic link adaptation by varying the modulation, coding and transmit power, and both dynamic and semi-static resource allocation. The DL-SCH also may enable broadcast in the entire cell and the use of beamforming. The system information carries one or more system information blocks. All system information blocks may be transmitted with the same periodicity. Traffic or control signals of a multimedia broadcast/multicast service (MBMS) may be transmitted through the DL-SCH or a multicast channel (MCH).

A UL transport channel for transmitting data from the UE to the network includes a random access channel (RACH) for transmitting an initial control message, a UL-SCH for transmitting user traffic or control signals, etc. The UL-SCH supports HARQ and dynamic link adaptation by varying the transmit power and potentially modulation and coding. The UL-SCH also may enable the use of beamforming. The RACH is normally used for initial access to a cell.

A MAC layer belongs to the L2. The MAC layer provides services to a radio link control (RLC) layer, which is a higher layer of the MAC layer, via a logical channel. The MAC layer provides a function of mapping multiple logical channels to multiple transport channels. The MAC layer also provides a function of logical channel multiplexing by mapping multiple logical channels to a single transport channel. A MAC sublayer provides data transfer services on logical channels.

The logical channels are classified into control channels for transferring control plane information and traffic channels for transferring user plane information, according to a type of transmitted information. That is, a set of logical channel types is defined for different data transfer services offered by the MAC layer. The logical channels are located above the transport channel, and are mapped to the transport channels.

The control channels are used for transfer of control plane information only. The control channels provided by the MAC layer include a broadcast control channel (BCCH), a paging control channel (PCCH), a common control channel (CCCH), a multicast control channel (MCCH) and a dedicated control channel (DCCH). The BCCH is a downlink channel for broadcasting system control information. The PCCH is a downlink channel that transfers paging information and is used when the network does not know the location cell of a UE. The CCCH is used by UEs having no RRC connection with the network. The MCCH is a point-to-multipoint downlink channel used for transmitting MBMS control information from the network to a UE. The DCCH is a point-to-point bi-directional channel used by UEs having an RRC connection that transmits dedicated control information between a UE and the network.

Traffic channels are used for the transfer of user plane information only. The traffic channels provided by the MAC layer include a dedicated traffic channel (DTCH) and a multicast traffic channel (MTCH). The DTCH is a point-to-point channel, dedicated to one UE for the transfer of user information and can exist in both uplink and downlink The MTCH is a point-to-multipoint downlink channel for transmitting traffic data from the network to the UE.

Uplink connections between logical channels and transport channels include the DCCH that can be mapped to the UL-SCH, the DTCH that can be mapped to the UL-SCH and the CCCH that can be mapped to the UL-SCH. Downlink connections between logical channels and transport channels include the BCCH that can be mapped to the BCH or DL-SCH, the PCCH that can be mapped to the PCH, the DCCH that can be mapped to the DL-SCH, and the DTCH that can be mapped to the DL-SCH, the MCCH that can be mapped to the MCH, and the MTCH that can be mapped to the MCH.

An RLC layer belongs to the L2. The RLC layer provides a function of adjusting a size of data, so as to be suitable for a lower layer to transmit the data, by concatenating and segmenting the data received from a higher layer in a radio section. In addition, to ensure a variety of quality of service (QoS) required by a radio bearer (RB), the RLC layer provides three operation modes, i.e., a transparent mode (TM), an unacknowledged mode (UM), and an acknowledged mode (AM). The AM RLC provides a retransmission function through an automatic repeat request (ARQ) for reliable data transmission. Meanwhile, a function of the RLC layer may be implemented with a functional block inside the MAC layer. In this case, the RLC layer may not exist.

A packet data convergence protocol (PDCP) layer belongs to the L2. The PDCP layer provides a function of header compression function that reduces unnecessary control information such that data being transmitted by employing IP packets, such as IPv4 or IPv6, can be efficiently transmitted over a radio interface that has a relatively small bandwidth. The header compression increases transmission efficiency in the radio section by transmitting only necessary information in a header of the data. In addition, the PDCP layer provides a function of security. The function of security includes ciphering which prevents inspection of third parties, and integrity protection which prevents data manipulation of third parties.

A radio resource control (RRC) layer belongs to the L3. The RLC layer is located at the lowest portion of the L3, and is only defined in the control plane. The RRC layer takes a role of controlling a radio resource between the UE and the network. For this, the UE and the network exchange an RRC message through the RRC layer. The RRC layer controls logical channels, transport channels, and physical channels in relation to the configuration, reconfiguration, and release of RBs. An RB is a logical path provided by the L1 and L2 for data delivery between the UE and the network. That is, the RB signifies a service provided the L2 for data transmission between the UE and E-UTRAN. The configuration of the RB implies a process for specifying a radio protocol layer and channel properties to provide a particular service and for determining respective detailed parameters and operations. The RB is classified into two types, i.e., a signaling RB (SRB) and a data RB (DRB). The SRB is used as a path for transmitting an RRC message in the control plane. The DRB is used as a path for transmitting user data in the user plane.

Referring to FIG. 2, the RLC and MAC layers (terminated in the eNB on the network side) may perform functions such as scheduling, automatic repeat request (ARQ), and hybrid automatic repeat request (HARM). The RRC layer (terminated in the eNB on the network side) may perform functions such as broadcasting, paging, RRC connection management, RB control, mobility functions, and UE measurement reporting and controlling The NAS control protocol (terminated in the MME of gateway on the network side) may perform functions such as a SAE bearer management, authentication, LTE_IDLE mobility handling, paging origination in LTE_IDLE, and security control for the signaling between the gateway and UE.

Referring to FIG. 3, the RLC and MAC layers (terminated in the eNB on the network side) may perform the same functions for the control plane. The PDCP layer (terminated in the eNB on the network side) may perform the user plane functions such as header compression, integrity protection, and ciphering.

An RRC state indicates whether an RRC layer of the UE is logically connected to an RRC layer of the E-UTRAN. The RRC state may be divided into two different states such as an RRC connected state and an RRC idle state. When an RRC connection is established between the RRC layer of the UE and the RRC layer of the E-UTRAN, the UE is in RRC_CONNECTED, and otherwise the UE is in RRC_IDLE. Since the UE in RRC_CONNECTED has the RRC connection established with the E-UTRAN, the E-UTRAN may recognize the existence of the UE in RRC_CONNECTED and may effectively control the UE. Meanwhile, the UE in RRC_IDLE may not be recognized by the E-UTRAN, and a CN manages the UE in unit of a TA which is a larger area than a cell. That is, only the existence of the UE in RRC_IDLE is recognized in unit of a large area, and the UE must transition to RRC_CONNECTED to receive a typical mobile communication service such as voice or data communication.

In RRC_IDLE state, the UE may receive broadcasts of system information and paging information while the UE specifies a discontinuous reception (DRX) configured by NAS, and the UE has been allocated an identification (ID) which uniquely identifies the UE in a tracking area and may perform public land mobile network (PLMN) selection and cell re-selection. Also, in RRC_IDLE state, no RRC context is stored in the eNB.

In RRC_CONNECTED state, the UE has an E-UTRAN RRC connection and a context in the E-UTRAN, such that transmitting and/or receiving data to/from the eNB becomes possible. Also, the UE can report channel quality information and feedback information to the eNB. In RRC_CONNECTED state, the E-UTRAN knows the cell to which the UE belongs. Therefore, the network can transmit and/or receive data to/from UE, the network can control mobility (handover and inter-radio access technologies (RAT) cell change order to GSM EDGE radio access network (GERAN) with network assisted cell change (NACC)) of the UE, and the network can perform cell measurements for a neighboring cell.

In RRC_IDLE state, the UE specifies the paging DRX cycle. Specifically, the UE monitors a paging signal at a specific paging occasion of every UE specific paging DRX cycle. The paging occasion is a time interval during which a paging signal is transmitted. The UE has its own paging occasion.

A paging message is transmitted over all cells belonging to the same tracking area. If the UE moves from one TA to another TA, the UE will send a tracking area update (TAU) message to the network to update its location.

When the user initially powers on the UE, the UE first searches for a proper cell and then remains in RRC_IDLE in the cell. When there is a need to establish an RRC connection, the UE which remains in RRC_IDLE establishes the RRC connection with the RRC of the E-UTRAN through an RRC connection procedure and then may transition to RRC_CONNECTED. The UE which remains in RRC_IDLE may need to establish the RRC connection with the E-UTRAN when uplink data transmission is necessary due to a user's call attempt or the like or when there is a need to transmit a response message upon receiving a paging message from the E-UTRAN.

It is known that different cause values may be mapped o the signature sequence used to transmit messages between a UE and eNB and that either channel quality indicator (CQI) or path loss and cause or message size are candidates for inclusion in the initial preamble.

When a UE wishes to access the network and determines a message to be transmitted, the message may be linked to a purpose and a cause value may be determined. The size of the ideal message may be also be determined by identifying all optional information and different alternative sizes, such as by removing optional information, or an alternative scheduling request message may be used.

The UE acquires necessary information for the transmission of the preamble, UL interference, pilot transmit power and required signal-to-noise ratio (SNR) for the preamble detection at the receiver or combinations thereof. This information must allow the calculation of the initial transmit power of the preamble. It is beneficial to transmit the UL message in the vicinity of the preamble from a frequency point of view in order to ensure that the same channel is used for the transmission of the message.

The UE should take into account the UL interference and the UL path loss in order to ensure that the network receives the preamble with a minimum SNR. The UL interference can be determined only in the eNB, and therefore, must be broadcast by the eNB and received by the UE prior to the transmission of the preamble. The UL path loss can be considered to be similar to the DL path loss and can be estimated by the UE from the received RX signal strength when the transmit power of some pilot sequence of the cell is known to the UE.

The required UL SNR for the detection of the preamble would typically depend on the eNB configuration, such as a number of Rx antennas and receiver performance. There may be advantages to transmit the rather static transmit power of the pilot and the necessary UL SNR separately from the varying UL interference and possibly the power offset required between the preamble and the message.

The initial transmission power of the preamble can be roughly calculated according to the following formula:

Transmit power=TransmitPilot−RxPilot+ULInterference+Offset+SNRRequired

Therefore, any combination of SNRRequired, ULInterference, TransmitPilot and Offset can be broadcast. In principle, only one value must be broadcast. This is essentially in current UMTS systems, although the UL interference in 3GPP LTE will mainly be neighboring cell interference that is probably more constant than in UMTS system.

The UE determines the initial UL transit power for the transmission of the preamble as explained above. The receiver in the eNB is able to estimate the absolute received power as well as the relative received power compared to the interference in the cell. The eNB will consider a preamble detected if the received signal power compared to the interference is above an eNB known threshold.

The UE performs power ramping in order to ensure that a UE can be detected even if the initially estimated transmission power of the preamble is not adequate. Another preamble will most likely be transmitted if no ACK or NACK is received by the UE before the next random access attempt. The transmit power of the preamble can be increased, and/or the preamble can be transmitted on a different UL frequency in order to increase the probability of detection. Therefore, the actual transmit power of the preamble that will be detected does not necessarily correspond to the initial transmit power of the preamble as initially calculated by the UE.

The UE must determine the possible UL transport format. The transport format, which may include MCS and a number of resource blocks that should be used by the UE, depends mainly on two parameters, specifically the SNR at the eNB and the required size of the message to be transmitted.

In practice, a maximum UE message size, or payload, and a required minimum SNR correspond to each transport format. In UMTS, the UE determines before the transmission of the preamble whether a transport format can be chosen for the transmission according to the estimated initial preamble transmit power, the required offset between preamble and the transport block, the maximum allowed or available UE transmit power, a fixed offset and additional margin. The preamble in UMTS need not contain any information regarding the transport format selected by the EU since the network does not need to reserve time and frequency resources and, therefore, the transport format is indicated together with the transmitted message.

The eNB must be aware of the size of the message that the UE intends to transmit and the SNR achievable by the UE in order to select the correct transport format upon reception of the preamble and then reserve the necessary time and frequency resources. Therefore, the eNB cannot estimate the SNR achievable by the EU according to the received preamble because the UE transmit power compared to the maximum allowed or possible UE transmit power is not known to the eNB, given that the UE will most likely consider the measured path loss in the DL or some equivalent measure for the determination of the initial preamble transmission power.

The eNB could calculate a difference between the path loss estimated in the DL compared and the path loss of the UL. However, this calculation is not possible if power ramping is used and the UE transmit power for the preamble does not correspond to the initially calculated UE transmit power. Furthermore, the precision of the actual UE transmit power and the transmit power at which the UE is intended to transmit is very low. Therefore, it has been proposed to code the path loss or CQI estimation of the downlink and the message size or the cause value in the UL in the signature.

Self-organizing networks (SON) enhancements are necessary for the interoperability of the existing features as well as for the new features and new deployments considered in 3GPP LTE rel-12.

In 3GPP LTE rel-11, mobility robustness optimization (MRO) has been enhanced to identify for which UE type the failure has occurred. Other SON use cases might require similar enhancements, for example, mobility load balancing (MLB) is not able to distinguish between UEs that support cell range expansion (CRE) and non-CRE UEs.

Active antennas allow the creation of multiple vertical and horizontal beams making the deployment dynamic. That enables dynamic cell splitting/merging to handle changing load conditions. For example, beams may be steered to distribute capacity precisely according to actual traffic mix, traffic location and user demands. That makes active antennas particularly good for suburban and rural areas, where fixed deployment of pico cells is expensive, but the network may face congestion situations nonetheless. SON can automate the network deployment based on active antennas.

To improve MLB and MRO functions, UE grouping has been considered. When CRE UEs and non-CRE UESs are considered as the UE grouping, a method for enhancement of mobility setting change may be required.

### SUMMARY OF INVENTION

### Technical Problem

The present invention provides a method and apparatus for transmitting mobility parameters in a wireless communication system. The present invention provides a method for transmitting mobility parameters for a cell range expansion (CRE) user equipment (UE) and mobility parameters for a non-CRE UE.

### Solution to Problem

In an aspect, a method for transmitting, by a first eNodeB (eNB), mobility parameters in a wireless communication system is provided. The method includes transmitting first mobility parameters for at least one of a cell range expansion (CRE) user equipment (UE) and a UE which is configured with an almost blank subframe (ABS), second mobility parameters for a non-CRE UE to a second eNB.

The first mobility parameters and the second mobility parameters may be transmitted via a mobility change request message.

The first mobility parameters may include handover trigger information of a first cell, which is controlled by the first eNB, for at least one of the CRE UE and the UE which is configured with the ABS, and the second mobility parameters may include handover trigger information of the first cell for the non-CRE UE.

The first mobility parameters may include handover trigger change information of a first cell, which is controlled by the first eNB, as compared to current values for at least one of the CRE UE and the UE which is configured with the ABS, and the second mobility parameters may include handover trigger change information of the first cell as compared to currents value for the non-CRE UE.

The first mobility parameters may include recommended values for handover trigger of a second cell, which is controlled by the second eNB, for at least one of the CRE UE and the UE which is configured with the ABS, and the second mobility parameters may include recommended values for handover trigger of the second cell for the non-CRE UE.

The first mobility parameters may include recommended values for handover trigger change of a second cell, which is controlled by the second eNB, as compared to current values for at least one of the CRE UE and the UE which is configured with the ABS, and the second mobility parameters may include recommended values for handover trigger change of the second cell as compared to current values for the non-CRE UE.

The method may further include receiving a mobility change acknowledge message from the second eNB.

The method may further include receiving a mobility change failure message from the second eNB. The mobility change failure message may include mobility parameters modification range information for at least one of the CRE UE and the UE which is configured with the ABS, and mobility parameters modification range information for the non-CRE UE.

In another aspect, a first eNodeB (eNB) in a wireless communication system is provided. The first eNB includes a radio frequency (RF) unit for transmitting or receiving a radio signal, and a processor coupled to the RF unit, and configure to transmit first mobility parameters for at least one of a cell range expansion (CRE) user equipment (UE) and a UE which is configured with an almost blank subframe (ABS), second mobility parameters for a non-CRE UE to a second eNB.

### Advantageous Effects of Invention

Mobility setting change can be performed effectively for CRE UE and non-CRE UE.

### BRIEF DESCRIPTION OF DRAWINGS

FIG. 1 shows LTE system architecture.

FIG. 2 shows a control plane of a radio interface protocol of an LTE system.

FIG. 3 shows a user plane of a radio interface protocol of an LTE system.

FIG. 4 shows an example of a physical channel structure.

FIGS. 5 and 6 show an intra-MME/S-GW handover procedure.

FIG. 7 shows a successful operation of mobility setting change procedure.

FIG. 8 shows an unsuccessful operation of mobility setting change procedure.

FIG. 9 shows concept and characteristic of CRE.

FIG. 10 shows an example of advantages of CRE in aspect of MLB.

FIG. 11 shows an example of advantages of CRE in aspect of MRO.

FIG. 12 shows an example of a method or transmitting mobility parameters according to an embodiment of the present invention.

FIG. 13 shows a wireless communication system to implement an embodiment of the present invention.

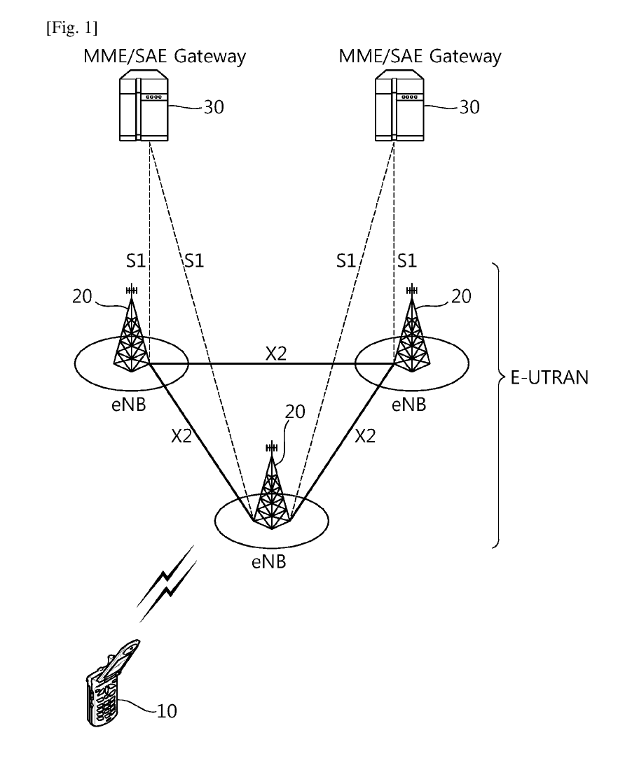

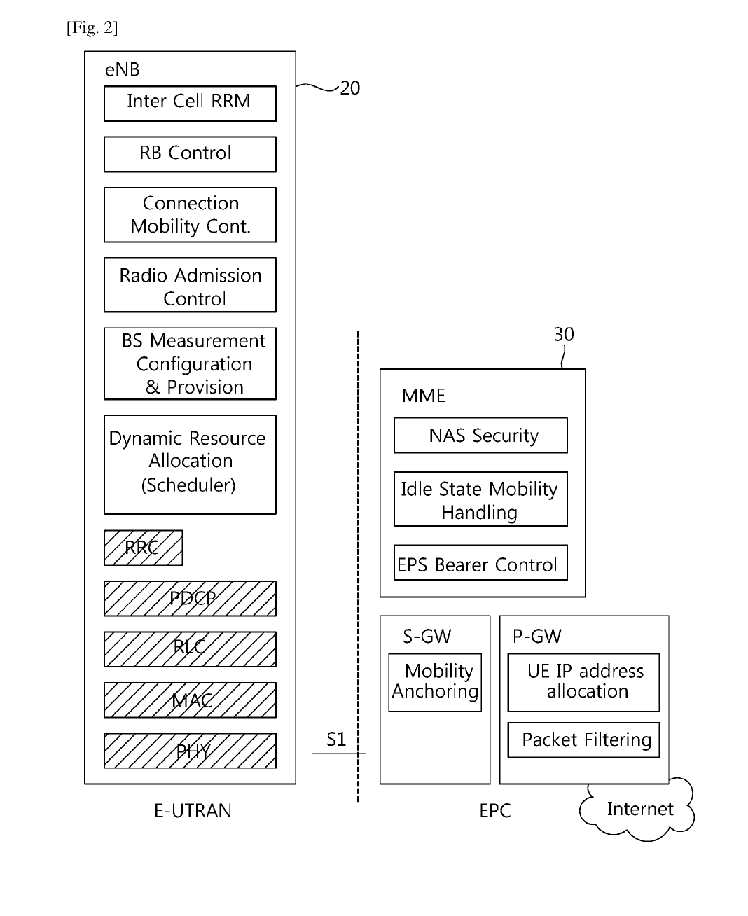

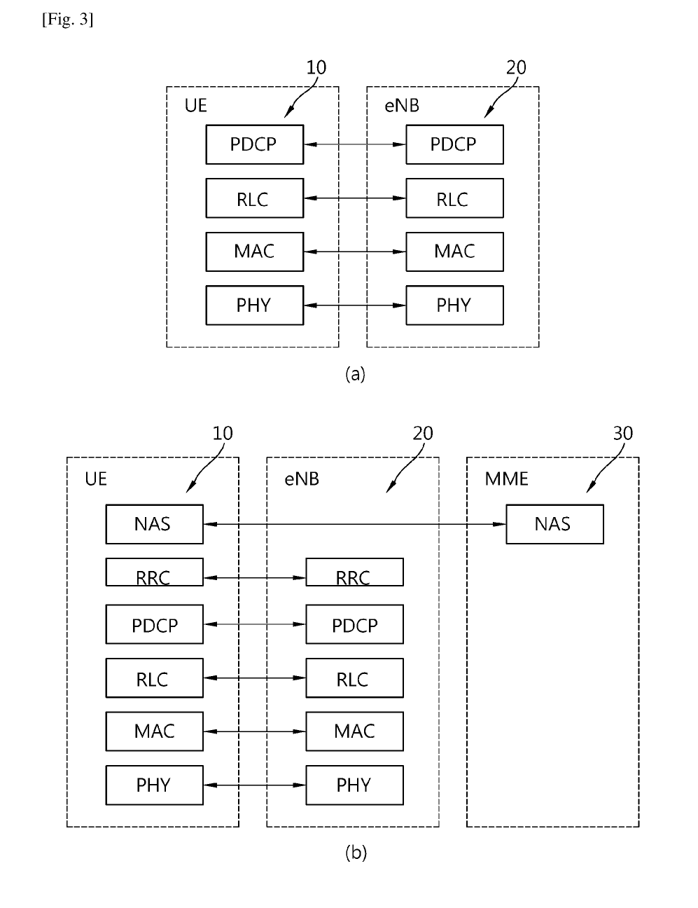

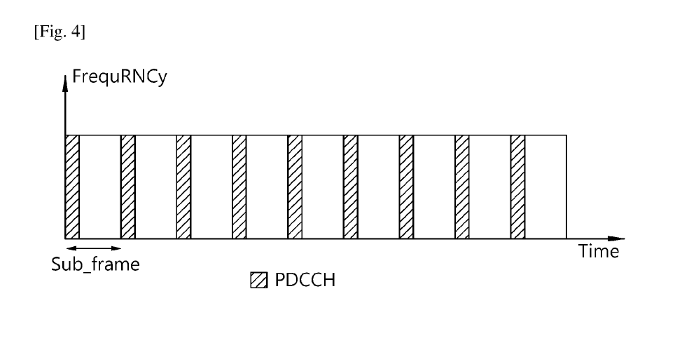

### MODE FOR THE INVENTION

The technology described below can be used in various wireless communication systems such as code division multiple access (CDMA), frequency division multiple access (FDMA), time division multiple access (TDMA), orthogonal frequency division multiple access (OFDMA), single carrier frequency division multiple access (SC-FDMA), etc. The CDMA can be implemented with a radio technology such as universal terrestrial radio access (UTRA) or CDMA-2000. The TDMA can be implemented with a radio technology such as global system for mobile communications (GSM)/general packet ratio service (GPRS)/enhanced data rate for GSM evolution (EDGE). The OFDMA can be implemented with a radio technology such as institute of electrical and electronics engineers (IEEE) 802.11 (Wi-Fi), IEEE 802.16 (WiMAX), IEEE 802-20, evolved UTRA (E-UTRA), etc. IEEE 802.16m is an evolution of IEEE 802.16e, and provides backward compatibility with an IEEE 802.16-based system. The UTRA is a part of a universal mobile telecommunication system (UMTS). 3rd generation partnership project (3GPP) long term evolution (LTE) is a part of an evolved UMTS (E-UMTS) using the E-UTRA. The 3GPP LTE uses the OFDMA in downlink and uses the SC-FDMA in uplink LTE-advance (LTE-A) is an evolution of the 3GPP LTE.

For clarity, the following description will focus on the LTE-A. However, technical features of the present invention are not limited thereto.

Handover (HO) is described. It may be referred to Section 10.1.2.1 of 3GPP TS 36.300 V11.4.0 (2012-December).

The intra E-UTRAN HO of a UE in RRC_CONNECTED state is a UE-assisted network-controlled HO, with HO preparation signaling in E-UTRAN:
Part of the HO command comes from the target eNB and is transparently forwarded to the UE by the source eNB;
To prepare the HO, the source eNB passes all necessary information to the target eNB (e.g., E-UTRAN radio access bearer (E-RAB) attributes and RRC context): When carrier aggregation (CA) is configured and to enable secondary cell (SCell) selection in the target eNB, the source eNB can provide in decreasing order of radio quality a list of the best cells and optionally measurement result of the cells.
Both the source eNB and UE keep some context (e.g., C-RNTI) to enable the return of the UE in case of HO failure;
UE accesses the target cell via RACH following a contention-free procedure using a dedicated RACH preamble or following a contention-based procedure if dedicated RACH preambles are not available: the UE uses the dedicated preamble until the handover procedure is finished (successfully or unsuccessfully);
If the RACH procedure towards the target cell is not successful within a certain time, the UE initiates radio link failure recovery using the best cell;
No robust header compression (ROHC) context is transferred at handover.

The preparation and execution phase of the HO procedure is performed without EPC involvement, i.e., preparation messages are directly exchanged between the eNBs. The release of the resources at the source side during the HO completion phase is triggered by the eNB. In case an RN is involved, its donor eNB (DeNB) relays the appropriate S1 messages between the RN and the MME (S1-based handover) and X2 messages between the RN and target eNB (X2-based handover); the DeNB is explicitly aware of a UE attached to the RN due to the S1 proxy and X2 proxy functionality.

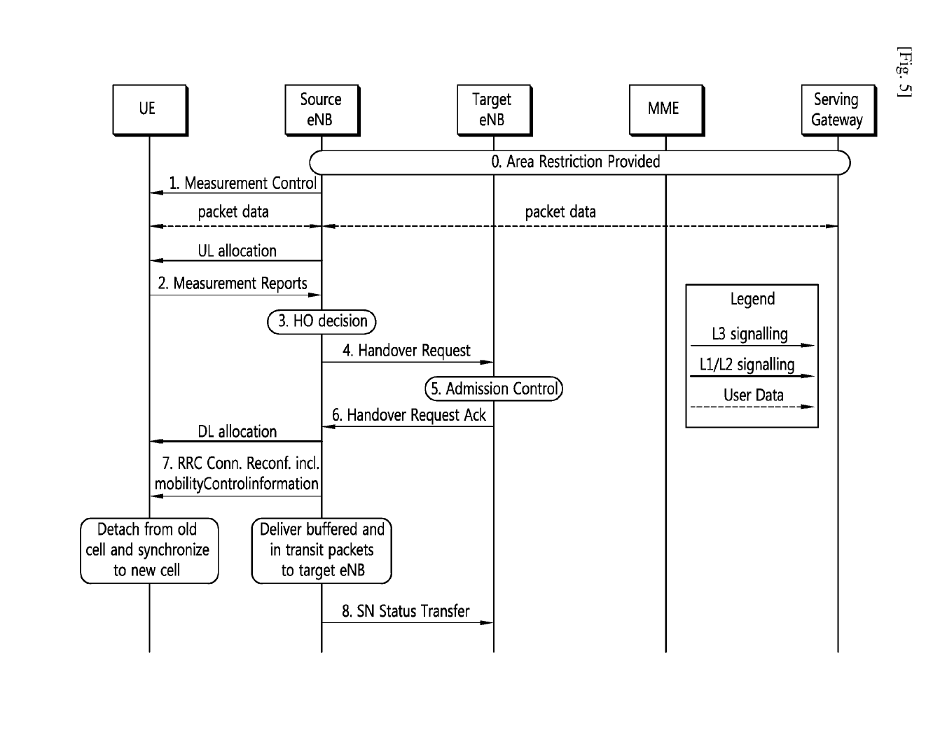

FIGS. 5 and 6 show an intra-MME/S-GW handover procedure.

0. The UE context within the source eNB contains information regarding roaming restrictions which were provided either at connection establishment or at the last TA update.

1. The source eNB configures the UE measurement procedures according to the area restriction information. Measurements provided by the source eNB may assist the function controlling the UE's connection mobility.

2. The UE is triggered to send measurement reports by the rules set by i.e., system information, specification, etc.

3. The source eNB makes decision based on measurement reports and radio resource management (RRM) information to hand off the UE.

4. The source eNB issues a handover request message to the target eNB passing necessary information to prepare the HO at the target side (UE X2 signalling context reference at source eNB, UE Si EPC signalling context reference, target cell identifier (ID), K_{eNB}*, RRC context including the cell radio network temporary identifier (C-RNTI) of the UE in the source eNB, AS-configuration, E-RAB context and physical layer ID of the source cell+short MAC-I for possible radio link failure (RLF) recovery). UE X2/UE S1 signalling references enable the target eNB to address the source eNB and the EPC. The E-RAB context includes necessary radio network layer (RNL) and transport network layer (TNL) addressing information, and quality of service (QoS) profiles of the E-RABs.

5. Admission Control may be performed by the target eNB dependent on the received E-RAB QoS information to increase the likelihood of a successful HO, if the resources can be granted by target eNB. The target eNB configures the required resources according to the received E-RAB QoS information and reserves a C-RNTI and optionally a RACH preamble. The AS-configuration to be used in the target cell can either be specified independently (i.e., an “establishment”) or as a delta compared to the AS-configuration used in the source cell (i.e., a “reconfiguration”).

6. The target eNB prepares HO with L1/L2 and sends the handover request acknowledge to the source eNB. The handover request acknowledge message includes a transparent container to be sent to the UE as an RRC message to perform the handover. The container includes a new C-RNTI, target eNB security algorithm identifiers for the selected security algorithms, may include a dedicated RACH preamble, and possibly some other parameters, i.e., access parameters, SIBs, etc. The handover request acknowledge message may also include RNL/TNL information for the forwarding tunnels, if necessary.

As soon as the source eNB receives the handover request acknowledge, or as soon as the transmission of the handover command is initiated in the downlink, data forwarding may be initiated.

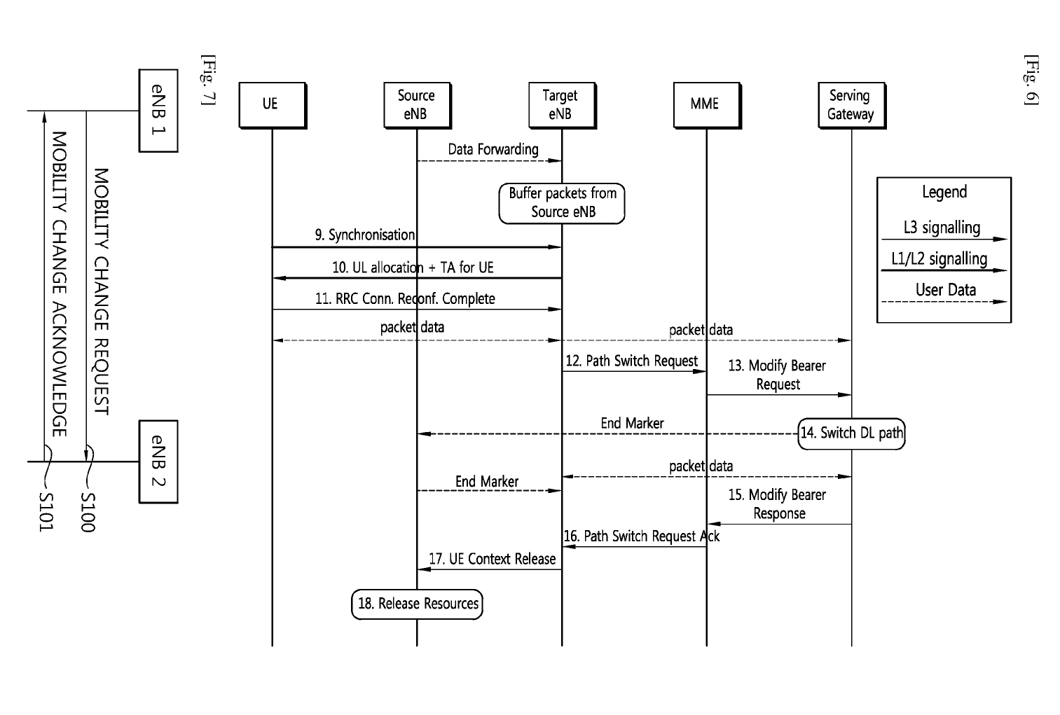

Steps 7 to 16 in FIGS. 6 and 7 provide means to avoid data loss during HO.

7. The target eNB generates the RRC message to perform the handover, i.e., RRC-ConnectionReconfiguration message including the mobilityControlInformation, to be sent by the source eNB towards the UE. The source eNB performs the necessary integrity protection and ciphering of the message. The UE receives the RRCConnectionReconfiguration message with necessary parameters (i.e. new C-RNTI, target eNB security algorithm identifiers, and optionally dedicated RACH preamble, target eNB SIBs, etc.) and is commanded by the source eNB to perform the HO. The UE does not need to delay the handover execution for delivering the HARQ/ARQ responses to source eNB.

8. The source eNB sends the sequence number (SN) status transfer message to the target eNB to convey the uplink PDCP SN receiver status and the downlink PDCP SN transmitter status of E-RABs for which PDCP status preservation applies (i.e., for RLC AM). The uplink PDCP SN receiver status includes at least the PDCP SN of the first missing UL service data unit (SDU) and may include a bit map of the receive status of the out of sequence UL SDUs that the UE needs to retransmit in the target cell, if there are any such SDUs. The downlink PDCP SN transmitter status indicates the next PDCP SN that the target eNB shall assign to new SDUs, not having a PDCP SN yet. The source eNB may omit sending this message if none of the E-RABs of the UE shall be treated with PDCP status preservation.

9. After receiving the RRCConnectionReconfiguration message including the mobilityControlInformation, UE performs synchronization to target eNB and accesses the target cell via RACH, following a contention-free procedure if a dedicated RACH preamble was indicated in the mobilityControlInformation, or following a contention-based procedure if no dedicated preamble was indicated. UE derives target eNB specific keys and configures the selected security algorithms to be used in the target cell.

10. The target eNB responds with UL allocation and timing advance.

11. When the UE has successfully accessed the target cell, the UE sends the RRC-ConnectionReconfigurationComplete message (C-RNTI) to confirm the handover, along with an uplink buffer status report, whenever possible, to the target eNB to indicate that the handover procedure is completed for the UE. The target eNB verifies the C-RNTI sent in the RRCConnectionReconfigurationComplete message. The target eNB can now begin sending data to the UE.

12. The target eNB sends a path switch request message to MME to inform that the UE has changed cell.

13. The MME sends a modify bearer request message to the serving gateway.

14. The serving gateway switches the downlink data path to the target side. The

Serving gateway sends one or more “end marker” packets on the old path to the source eNB and then can release any U-plane/TNL resources towards the source eNB.

15. The serving gateway sends a modify bearer response message to MME.

16. The MME confirms the path switch request message with the path switch request acknowledge message.

17. By sending the UE context release message, the target eNB informs success of HO to source eNB and triggers the release of resources by the source eNB. The target eNB sends this message after the path switch request acknowledge message is received from the MME.

18. Upon reception of the UE context release message, the source eNB can release radio and C-plane related resources associated to the UE context. Any ongoing data forwarding may continue.

Mobility setting change is described. It may be referred to Section 8.3.8 of 3GPP TS 36.423 V11.2.0 (2012-December). The mobility setting change procedure enables an eNB to negotiate the handover trigger settings with a peer eNB controlling neighboring cells. The mobility setting change procedure uses non UE-associated signaling.

FIG. 7 shows a successful operation of mobility setting change procedure. In step S100, the mobility setting change procedure is initiated with a MOBILITY CHANGE REQUEST message sent from the eNB 1 to the eNB2. Upon receiving the MOBILITY CHANGE REQUEST message, the eNB 2 shall evaluate if the proposed eNB2 handover trigger modification may be accepted. If the eNB2 is able to successfully complete the request, in step S101, the eNB2 shall reply with a MOBILITY CHANGE ACKNOWLEDGE message.

Table 1 shows the MOBILITY CHANGE REQUEST message. It may be referred to Section 9.1.2.15 of 3GPP TS 36.423 V11.2.0 (2012-September).

TABLE 1

| | | | | | | |
|---|---|---|---|---|---|---|
| | | | | | | As- |
| IE/ | | | IE | Semantics | | signed |
| Group | Pres- | | type and | descrip- | Criti- | Criti- |
| Name | ence | Range | reference | tion | cality | cality |

| | | | | | |
|---|---|---|---|---|---|
| Message | M | 9.2.13 | | YES | reject |
| Type | | | | | |
| eNB1 Cell | M | ECGI | | YES | reject |
| ID | | 9.2.14 | | | |
| eNB2 Cell | M | ECGI | | YES | reject |
| ID | | 9.2.14 | | | |
| eNB1 | O | Mobility | Config- | YES | ignore |
| Mobility | | Parameters | uration | | |
| Parameters | | Information | change in | | |
| | | 9.2.48 | eNB₁ cell. | | |
| eNB2 | M | Mobility | Proposed | YES | reject |
| Proposed | | Parameters | config- | | |
| Mobility | | Information | uration | | |
| Parameters | | 9.2.48 | change in | | |
| | | | eNB₂ cell. | | |
| Cause | M | 9.2.6 | | YES | reject |

Table 2 shows the Mobility Parameters Information IE. It may be referred to Section 9.2.48 of 3GPP TS 36.423 V11.2.0 (2012-September). The Mobility Parameters Information IE contains the change of the Handover Trigger as compared to its current value. The Handover Trigger corresponds to the threshold at which a cell initializes the handover preparation procedure towards a specific neighbor cell. Positive value of the change means the handover is proposed to take place later.

TABLE 2

| IE/ | | | IE type and | Semantics |
|---|---|---|---|---|
| Group Name | Presence | Range | reference | description |
| Handover | M | | INTEGER | The actual value is |
| Trigger | | | (−20 . . . 20) | IE value * 0.5 dB. |
| Change | | | | |

Table 3 shows the MOBILITY CHANGE ACKNOWLEDGE message. It may be referred to Section 9.1.2.16 of 3GPP TS 36.423 V11.2.0 (2012-September).

TABLE 3

| | | | IE type and | Semantics | | Assigned |
|---|---|---|---|---|---|---|
| IE/Group Name | Presence | Range | reference | description | Criticality | Criticality |
| Message Type | M | | 9.2.13 | | YES | reject |
| eNB1 Cell ID | M | | ECGI | | YES | reject |
| eNB2 Cell ID | M | | ECGI | | YES | reject |
| Criticality Diagnostics | O | | 9.2.7 | | YES | ignore |

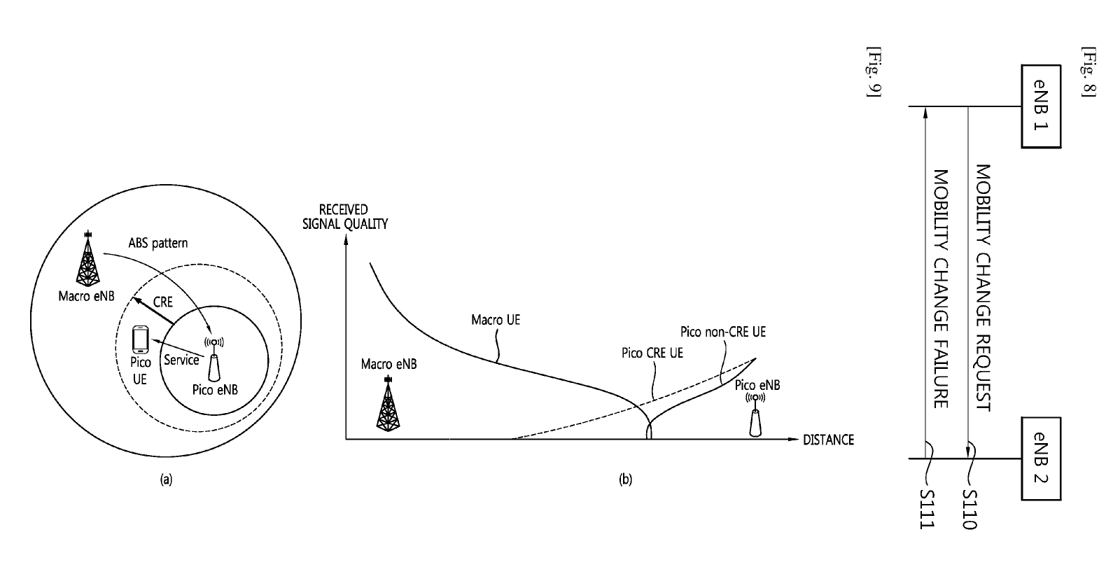

FIG. 8 shows an unsuccessful operation of mobility setting change procedure. In step S110, the eNB1 transmits the MOBILITY CHANGE REQUEST message to the eNB2. If the requested parameter modification is refused by the eNB2, or if the eNB2 is not able to complete the procedure, the eNB2 shall send a MOBILITY CHANGE FAILURE message with the Cause IE set to an appropriate value. The eNB2 may include eNB2 Mobility Parameters Modification Range IE in the MOBILITY CHANGE FAILURE message, for example in cases when the proposed change is out of permitted range.

Table 4 shows the MOBILITY CHANGE FAILURE message. It may be referred to Section 9.1.2.17 of 3GPP TS 36.423 V11.2.0 (2012-September).

TABLE 4

| | | | IE type and | Semantics | | Assigned |
|---|---|---|---|---|---|---|
| IE/Group Name | Presence | Range | reference | description | Criticality | Criticality |
| Message Type | M | | 9.2.13 | | YES | reject |
| eNB1 Cell ID | M | | ECGI | | YES | ignore |
| eNB2 Cell ID | M | | ECGI | | YES | ignore |
| Cause | M | | 9.2.6 | | YES | ignore |
| eNB2 Mobility Parameters | O | | 9.2.49 | | YES | ignore |
| Modification | | | | | | |
| Range | | | | | | |
| Criticality Diagnostics | O | | 9.2.7 | | YES | ignore |

Table 5 shows the Mobility Parameters Modification Range IE. It may be referred to Section 9.2.49 of 3GPP TS 36.423 V11.2.0 (2012-September). The Mobility Parameters Modification Range IE contains the range of Handover Trigger Change values permitted by the eNB2 at the moment the MOBILITY CHANGE FAILURE message is sent.

TABLE 5

| IE/ | | | IE type and | Semantics |
|---|---|---|---|---|
| Group Name | Presence | Range | reference | description |
| Handover | M | | INTEGER | The actual value is |
| Trigger | | | (−20 . . . 20) | IE value * 0.5 dB. |
| Change | | | | |
| Lower Limit | | | | |
| Handover | M | | INTEGER | The actual value is |
| Trigger | | | (−20 . . . 20) | IE value * 0.5 dB. |
| Change | | | | |
| Upper Limit | | | | |

Cell range expansion (CRE) is described.

FIG. 9 shows concept and characteristic of CRE.

FIG. 9-(a) shows the operation of CRE. The macro eNB assigns an almost blank subframe (ABS) pattern for specific resource blocks to the pico eNB. The almost blank subframes are subframes with reduced power on some physical channels and/or reduced activity. That is, the macro eNB may not transmit anything through the almost blank subframes. Then, through these almost blank subframes, the pico eNB can serve UEs without interferences from the macro eNB, and it leads the effect of substantially expanding coverage of the pico cell. Accordingly, a pico UE, which is located little bit outside of the coverage of the pico cell, may receive services from the pico eNB. It means that the geographical handover triggering spot for UEs in which the resource blocks of the ABS pattern are assigned becomes different from one for UEs in which the resource blocks not related to the ABS pattern are assigned.

FIG. 9-(b) shows the variation of received signal quality of a macro UE, a pico CRE UE and a pico non-CRE UE through the distance from each eNB. Received signal quality of the macro UE decreases as the distance from the macro eNB increases. Likewise, received signal quality of the pico CRE UE and pico non-CRE UE decreases as the distance from the pico eNB increases. However, the received signal quality curves for the pico CRE UE and pico non-CRE UE have different characteristics each other. As shown in FIG. 7-(b), the slope of the received signal quality for the pico CRE UE is relatively slower than the slope of the received signal quality for pico non-CRE UE.

Because of these different characteristics between the CRE UE and non-CRE UE, if different handover parameters are set for the CRE UE and non-CRE UE separately, several advantages in aspect of mobility load balancing (MLB) and mobility robustness optimization (MRO) exist.

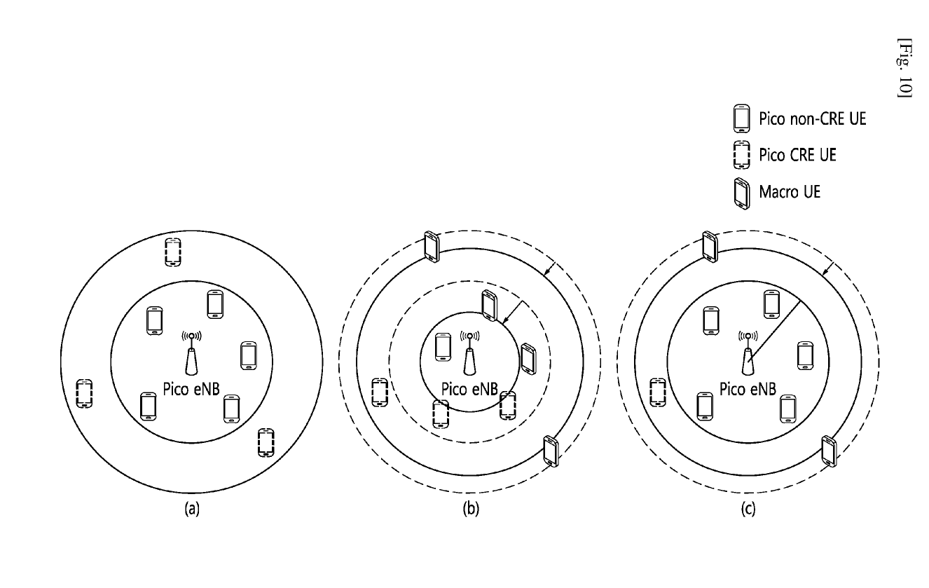

FIG. 10 shows an example of advantages of CRE in aspect of MLB.

Referring to FIG. 10-(a), before mobility setting change, five pico non-CRE UEs are located in coverage of the pico eNB, and three pico CRE UEs are located in the CRE area. The three pico CRE UEs in the CRE area cannot be served by the pico eNB without assignment of the ABS pattern.

If the pico eNB changes mobility parameters for both pico CRE UEs and pico non-CRE UEs, in case that the pico eNB wants to handover one or two UEs to the macro eNB due to the purpose of load balancing and/or the limited ABS resource, two pico CRE UEs and two pico non-CRE UEs are handed over to the macro eNB as shown in FIG. 10-(b). That is, as the coverage of the pico cell decreases, two pico non-CRE UEs among the five pico non-CRE UEs are handed over to the macro eNB, after mobility setting change. Also, as the coverage of CRE area decreases, two pico CRE UEs among the three pico CRE UEs are handed over to the macro eNB, after mobility setting change. Therefore, load of the pico eNB may be reduced more efficiently.

On the other hand, if the pico eNB changes mobility parameters for only pico CRE UEs, then it is possible to handover two pico CRE UEs and to continue to serve all pico non-CRE UEs, as shown in FIG. 10-(c). That is, as the coverage of CRE area decreases, two pico CRE UEs among the three pico CRE UEs are handed over to the macro eNB. The five pico non-CRE UEs are served by the pico eNB as it is, after mobility setting change. Therefore, load of the pico eNB may not be reduced enough.

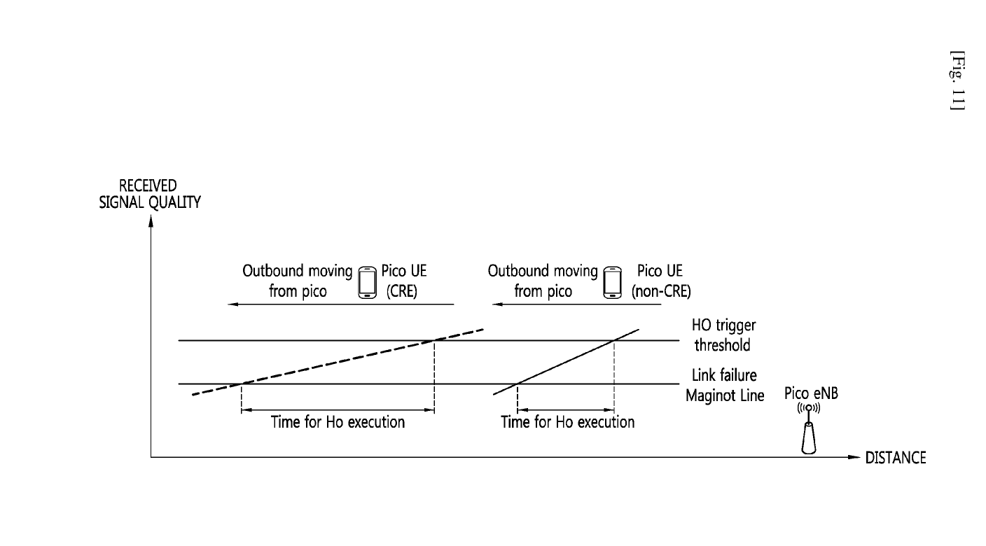

FIG. 11 shows an example of advantages of CRE in aspect of MRO.

Generally, because the pico CRE UE is not interfered from the macro eNB, the received signal quality of the pico CRE UE declines more gradually than the received signal quality of the pico non-CRE UE as the distance from the pico eNB increases, as shown in FIG. 9. It means that if the pico eNB sets an identical handover parameter for both the pico CRE UE and pico non-CRE UE, the available time for handover execution of the pico CRE UE is much longer than the available time for handover execution of non-CRE UE, as shown in FIG. 11. In the pico CRE UE's point of view, though it may be stayed longer in the pico cell, handover may be triggered too fast. Moreover, in the pico non-CRE UE's point of view, due to the short time allowed for handover execution, the possibility of handover failure may become higher. Therefore, if separated management of handover parameters for the pico CRE UE and pico non-CRE UE is possible, handover operation may become more efficient.

Separated management of handover parameters for pico CRE UE and pico non-CRE UE may be implemented in the eNB. However, the problem is that currently the mobility setting change procedure which is used to exchange handover parameters between eNBs supports only one kind of handover parameter. Therefore even though separated management of handover parameters for pico CRE UE and pico non-CRE UE would be implemented, the eNB cannot suggest and recognize two kinds of handover parameters of neighbor cell.

Hereinafter, a method for transmitting mobility parameters for CRE UE and mobility parameters for non-CRE UE according to embodiments of the present invention is described. In the description below, the Handover Trigger corresponds to the threshold at which a cell initializes the handover preparation procedure towards a specific neighbor cell. In addition, in the description below, the CRE UE may be a UE which is configured with ABS.

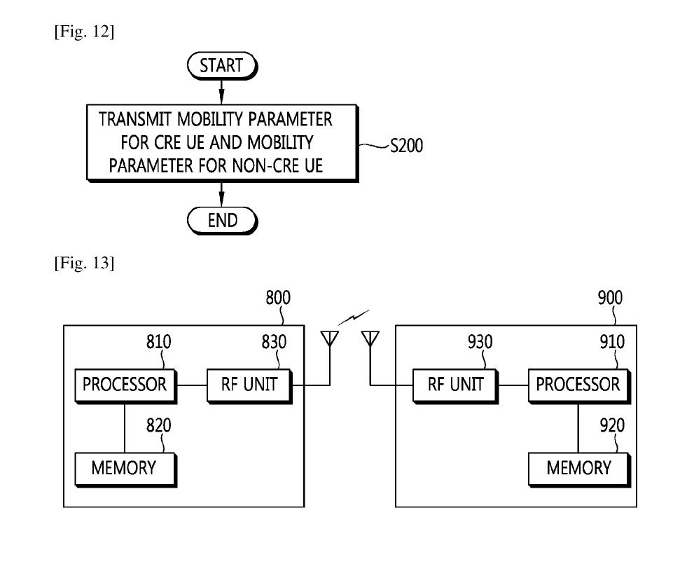

FIG. 12 shows an example of a method or transmitting mobility parameters according to an embodiment of the present invention. In step S200, the eNB 1 transmits mobility parameters for CRE UE and mobility parameters for non-CRE UE to the eNB2. The eNB 1 may transmit various kinds of mobility parameters for CRE UE and non-CRE UE to the eNB2.

1) The eNB 1 may transmit the Handover Trigger information of its own cell for both CRE UE and non-CRE UE to the neighbor eNB2.

2) The eNB 1 may transmit the Handover Trigger change information of its own cell as compared to its current values for both CRE UE and non-CRE UE to the neighbor eNB2.

3) The eNB 1 may transmit the recommended values for the Handover Trigger of neighbor cell (of the eNB2) for both CRE UE and non-CRE UE to the neighbor eNB2.

4) The eNB 1 may transmit the recommended values for the handover Trigger change of neighbor cell (of the eNB2) as compared to its current value for both CRE UE and non-CRE UE to the neighbor eNB2.

The MOBILITY CHANGE REQUEST message described in Table 1 above may be modified to Table 6 below according to the embodiment of the present invention.

TABLE 6

| | | | IE type and | Semantics | | Assigned |
|---|---|---|---|---|---|---|
| IE/Group Name | Presence | Range | reference | description | Criticality | Criticality |
| Message Type | M | | 9.2.13 | | YES | reject |
| eNB1 Cell ID | M | | ECGI | | YES | reject |
| | | | 9.2.14 | | | |
| eNB2 Cell ID | M | | ECGI | | YES | reject |
| | | | 9.2.14 | | | |
| eNB1 Mobility Parameters | O | | Mobility | Configuration | YES | ignore |
| for CRE | | | Parameters | change | | |
| UE | | | Information | in eNB₁ | | |
| | | | 9.2.48 | cell | | |
| eNB1 Mobility Parameters | O | | Mobility | Configuration | YES | ignore |
| for non-CRE UE | | | Parameters | change | | |
| | | | Information | in eNB₁ | | |
| | | | 9.2.48 | cell | | |
| eNB2 Proposed | O | | Mobility | Proposed | YES | reject |
| Mobility Parameters | | | Parameters | Configuration | | |
| for CRE | | | Information | change | | |
| UE | | | 9.2.48 | in eNB₂ | | |
| | | | | cell | | |
| eNB2 Proposed | O | | Mobility | Proposed | YES | reject |
| Mobility Parameters | | | Parameters | Configuration | | |
| for non- | | | Information | change | | |
| CRE UE | | | 9.2.48 | in eNB₂ | | |
| | | | | cell | | |
| Cause | M | | 9.2.6 | | YES | reject |

Referring to Table 6, the MOBILITY CHANGE REQUEST message according to the embodiment of the present invention includes mobility parameters for both CRE UE and non-CRE UE. The eNB 1 Mobility parameters for CRE UE IE and the eNB 1 Mobility parameters for non-CRE UE IE may correspond to the Handover Trigger change information of its own cell as compared to its current values for both CRE UE and non-CRE UE, which is described in 2) above. The eNB2 Proposed Mobility Parameters for CRE UE IE and eNB2 Proposed Mobility Parameters for non-CRE UE IE may correspond to the recommended values for the handover Trigger change of neighbor cell (of the eNB2) as compared to its current values for both CRE UE and non-CRE UE, which is described in 2) above. The Mobility Parameter Information IE may use the Table 2 describe above.

The MOBILITY CHANGE FAILURE message described in Table 4 above may be modified to Table 7 below according to the embodiment of the present invention.

TABLE 7

| | | | IE type and | Semantics | | Assigned |
|---|---|---|---|---|---|---|
| IE/Group Name | Presence | Range | reference | description | Criticality | Criticality |
| Message Type | M | | 9.2.13 | | YES | reject |
| eNB1 Cell ID | M | | ECGI | | YES | ignore |
| eNB2 Cell ID | M | | ECGI | | YES | ignore |
| Cause | M | | 9.2.6 | | YES | ignore |
| eNB2 Mobility | O | | 9.2.49 | | YES | ignore |
| Parameters Modification | | | | | | |
| Range for | | | | | | |
| CRE UE | | | | | | |
| eNB2 Mobility | O | | 9.2.49 | | YES | ignore |
| Parameters Modification | | | | | | |
| Range for | | | | | | |
| non CRE UE | | | | | | |
| Criticality Diagnostics | O | | 9.2.7 | | YES | ignore |

Referring to Table 7, the MOBILITY CHANGE FAILURE message according to the embodiment of the present invention includes mobility parameters for both CRE UE and non-CRE UE, i.e., the eNB2 Mobility Parameters Modification Range for CRE UE IE and the eNB2 Mobility Parameters Modification Range for non CRE UE IE. The Mobility Parameter Modification Range IE may use the Table 5 describe above.

Alternatively, the eNB 1 may transmit mobility parameters for CRE UE to the eNB2. The eNB 1 may transmit various kinds of mobility parameters for CRE UE to the eNB2.

1) The eNB 1 may transmit the Handover Trigger information of its own cell for CRE UE to the neighbor eNB2.

2) The eNB 1 may transmit the Handover Trigger change information of its own cell as compared to its current values for CRE UE to the neighbor eNB2.

3) The eNB 1 may transmit the recommended values for the Handover Trigger of neighbor cell (of the eNB2) for CRE UE to the neighbor eNB2.

4) The eNB 1 may transmit the recommended values for the handover Trigger change of neighbor cell (of the eNB2) as compared to its current values for CRE UE to the neighbor eNB2.

The MOBILITY CHANGE REQUEST message described in Table 1 above may be modified to Table 8 below according to the embodiment of the present invention.

TABLE 8

| | | | IE type and | Semantics | | Assigned |
|---|---|---|---|---|---|---|
| IE/Group Name | Presence | Range | reference | description | Criticality | Criticality |
| Message Type | M | | 9.2.13 | | YES | reject |
| eNB1 Cell ID | M | | ECGI | | YES | reject |
| | | | 9.2.14 | | | |
| eNB2 Cell ID | M | | ECGI | | YES | reject |
| | | | 9.2.14 | | | |
| eNB1 Mobility Parameters | O | | Mobility | Configuration | YES | ignore |
| | | | Parameters | change | | |
| | | | Information | in eNB₁ | | |
| | | | 9.2.48 | cell | | |
| >CRE UE | | | ENUMERATED | Target UE | | |
| | | | (CRE UE, | for the | | |
| | | | non-CRE | mobility | | |
| | | | UE, . . . ) | parameters | | |
| | | | | change | | |
| eNB2 Proposed | M | | Mobility | Proposed | YES | reject |
| Mobility Parameters | | | Parameters | configuration | | |
| | | | Information | change | | |
| | | | 9.2.48 | in eNB₂ | | |
| | | | | cell | | |
| >CRE UE | | | ENUMERATED | Target UE | | |
| | | | (CRE UE, | for the | | |
| | | | non-CRE | mobility | | |
| | | | UE, . . . ) | parameters | | |
| | | | | change | | |
| Cause | M | | 9.2.6 | | YES | reject |

Referring to Table 8, the MOBILITY CHANGE REQUEST message according to the embodiment of the present invention includes mobility parameters for CRE UE. The CRE UE is target UE for the mobility parameters change. The eNB 1 Mobility parameters IE for CRE UE may correspond to the Handover Trigger change information of its own cell as compared to its current values for CRE UE, which is described in 2) above. The eNB2 Proposed Mobility Parameters IE for CRE UE may correspond to the recommended values for the handover Trigger change of neighbor cell (of the eNB2) as compared to its current values for CRE UE, which is described in 2) above. The Mobility Parameter Information IE may use the Table 2 describe above.

The MOBILITY CHANGE FAILURE message described in Table 4 above may be modified to Table 9 below according to the embodiment of the present invention.

TABLE 9

| | | | IE type and | Semantics | | Assigned |
|---|---|---|---|---|---|---|
| IE/Group Name | Presence | Range | reference | description | Criticality | Criticality |
| Message Type | M | | 9.2.13 | | YES | reject |
| eNB1 Cell ID | M | | ECGI | | YES | ignore |
| eNB2 Cell ID | M | | ECGI | | YES | ignore |
| Cause | M | | 9.2.6 | | YES | ignore |
| eNB2 Mobility Parameters | O | | 9.2.49 | | YES | ignore |
| Modification | | | | | | |
| Range | | | | | | |
| >CRE UE | | | ENUMERATED | Corresponding | | |
| | | | (CRE UE, | UE | | |
| | | | non-CRE UE, . . . ) | for the | | |
| | | | | mobility | | |
| | | | | parameters | | |
| | | | | modification | | |
| | | | | range | | |
| Criticality Diagnostics | O | | 9.2.7 | | YES | ignore |

Referring to Table 9, the MOBILITY CHANGE FAILURE message according to the embodiment of the present invention includes mobility parameters for CRE UE, i.e., the eNB2 Mobility Parameters Modification Range IE for CRE UE. The CRE UE is target UE for the mobility parameters change. The Mobility Parameter Modification Range IE may use the Table 5 describe above.

FIG. 13 shows a wireless communication system to implement an embodiment of the present invention.

A first eNB 800 includes a processor 810, a memory 820, and a radio frequency (RF) unit 830. The processor 810 may be configured to implement proposed functions, procedures, and/or methods in this description. Layers of the radio interface protocol may be implemented in the processor 810. The memory 820 is operatively coupled with the processor 810 and stores a variety of information to operate the processor 810. The RF unit 830 is operatively coupled with the processor 810, and transmits and/or receives a radio signal.

A second eNB 900 may include a processor 910, a memory 920 and a RF unit 930. The processor 910 may be configured to implement proposed functions, procedures and/or methods described in this description. Layers of the radio interface protocol may be implemented in the processor 910. The memory 920 is operatively coupled with the processor 910 and stores a variety of information to operate the processor 910. The RF unit 930 is operatively coupled with the processor 910, and transmits and/or receives a radio signal.

The processors 810, 910 may include application-specific integrated circuit (ASIC), other chipset, logic circuit and/or data processing device. The memories 820, 920 may include read-only memory (ROM), random access memory (RAM), flash memory, memory card, storage medium and/or other storage device. The RF units 830, 930 may include baseband circuitry to process radio frequency signals. When the embodiments are implemented in software, the techniques described herein can be implemented with modules (e.g., procedures, functions, and so on) that perform the functions described herein. The modules can be stored in memories 820, 920 and executed by processors 810, 910. The memories 820, 920 can be implemented within the processors 810, 910 or external to the processors 810, 910 in which case those can be communicatively coupled to the processors 810, 910 via various means as is known in the art.

In view of the exemplary systems described herein, methodologies that may be implemented in accordance with the disclosed subject matter have been described with reference to several flow diagrams. While for purposed of simplicity, the methodologies are shown and described as a series of steps or blocks, it is to be understood and appreciated that the claimed subject matter is not limited by the order of the steps or blocks, as some steps may occur in different orders or concurrently with other steps from what is depicted and described herein. Moreover, one skilled in the art would understand that the steps illustrated in the flow diagram are not exclusive and other steps may be included or one or more of the steps in the example flow diagram may be deleted without affecting the scope and spirit of the present disclosure.

1. A method for transmitting, by a first eNodeB (eNB), mobility parameters in a wireless communication system, the method comprising:
transmitting first mobility parameters for at least one of a cell range expansion (CRE) user equipment (UE) and a UE which is configured with an almost blank subframe (ABS), and second mobility parameters for a non-CRE UE to a second eNB.

2. The method of claim 1, wherein the first mobility parameters and the second mobility parameters are transmitted via a mobility change request message.

3. The method of claim 1, wherein the first mobility parameters includes handover trigger information of a first cell, which is controlled by the first eNB, for at least one of the CRE UE and the UE which is configured with the ABS, and
wherein the second mobility parameters includes handover trigger information of the first cell for the non-CRE UE.

4. The method of claim 1, wherein the first mobility parameters includes handover trigger change information of a first cell, which is controlled by the first eNB, as compared to current values for at least one of the CRE UE and the UE which is configured with the ABS, and
wherein the second mobility parameters includes handover trigger change information of the first cell as compared to currents value for the non-CRE UE.

5. The method of claim 1, wherein the first mobility parameters includes recommended values for handover trigger of a second cell, which is controlled by the second eNB, for at least one of the CRE UE and the UE which is configured with the ABS, and
wherein the second mobility parameters includes recommended values for handover trigger of the second cell for the non-CRE UE.

6. The method of claim 1, wherein the first mobility parameters includes recommended values for handover trigger change of a second cell, which is controlled by the second eNB, as compared to current values for at least one of the CRE UE and the UE which is configured with the ABS, and
wherein the second mobility parameters includes recommended values for handover trigger change of the second cell as compared to current values for the non-CRE UE.

7. The method of claim 1, further comprising:
receiving a mobility change acknowledge message from the second eNB.

8. The method of claim 1, further comprising:
receiving a mobility change failure message from the second eNB.

9. The method of claim 8, wherein the mobility change failure message includes mobility parameters modification range information for at least one of the CRE UE and the UE which is configured with the ABS, and mobility parameters modification range information for the non-CRE UE.

10. A first eNodeB (eNB) in a wireless communication system, the first eNB comprising:
a radio frequency (RF) unit for transmitting or receiving a radio signal; and
a processor coupled to the RF unit, and configure to:
transmit first mobility parameters for at least one of a cell range expansion (CRE) user equipment (UE) and a UE which is configured with an almost blank subframe (ABS), second mobility parameters for a non-CRE UE to a second eNB.

11. The first eNB of claim 10, wherein the first mobility parameters and the second mobility parameters are transmitted via a mobility change request message.

12. The first eNB of claim 10, wherein the first mobility parameters includes handover trigger information of a first cell, which is controlled by the first eNB, for at least one of the CRE UE and the UE which is configured with the ABS, and
wherein the second mobility parameters includes handover trigger information of the first cell for the non-CRE UE.

13. The first eNB of claim 10, wherein the first mobility parameters includes handover trigger change information of a first cell, which is controlled by the first eNB, as compared to current values for at least one of the CRE UE and the UE which is configured with the ABS, and wherein the second mobility parameters includes handover trigger change information of the first cell as compared to currents value for the non-CRE UE.

14. The first eNB of claim 10, wherein the first mobility parameters includes recommended values for handover trigger of a second cell, which is controlled by the second eNB, for at least one of the CRE UE and the UE which is configured with the ABS, and
wherein the second mobility parameters includes recommended values for handover trigger of the second cell for the non-CRE UE.

151. The first eNB of claim 10, wherein the first mobility parameters includes recommended values for handover trigger change of a second cell, which is controlled by the second eNB, as compared to current values for at least one of the CRE UE and the UE which is configured with the ABS, and
wherein the second mobility parameters includes recommended values for handover trigger change of the second cell as compared to current values for the non-CRE UE.
